(19) United States
(12) Patent Application Publication
(10) Pub. No.: US 2017/0057425 A1
(43) Pub. Date: Mar. 2, 2017

(54) TRUCK BED RAIL CAP ASSEMBLY

(71) Applicant: GM Global Technology Operations LLC, Detroit, MI (US)

(72) Inventors: Mark A. Pulleyblank, Harrison Township, MI (US); Randy S. Bugbee, Grand Blanc, MI (US)

(21) Appl. No.: 14/835,900

(22) Filed: Aug. 26, 2015

(51) Int. Cl. B60R 13/01

(52) U.S. Cl. CPC B60R 13/01

(57) ABSTRACT

A number of variations may include a vehicle which may have a bed portion and a bed rail cap assembly operably coupled to the bed portion. The bed rail cap assembly may include at least one extruded beam having a plurality of T-slot profiles. Additionally, the bed rail cap assembly may be constructed and arranged to match a contour of the bed portion.

### TECHNICAL FIELD

The field to which the disclosure generally relates to includes vehicles and vehicle beds and methods of making and using the same.

### BACKGROUND

Vehicles may include various designs of vehicle beds.

### SUMMARY OF ILLUSTRATIVE VARIATIONS

A number of variations may include a vehicle which may include a bed portion. Additionally, a bed rail cap assembly, which may have at least one extruded beam having a plurality of T-slot profiles may be operably coupled to the bed portion. Also, the bed rail cap assembly may be constructed and arranged to match a contour of the bed portion.

A number of variations may include a vehicle bed which may include a bed portion and a rail cap assembly which may be operably coupled to the bed portion. The bed rail cap assembly may include at least one extruded beam having a plurality of T-slot profiles. Additionally, the bed rail cap assembly may be constructed and arranged to match every contour of the bed portion.

A number of variations may include a vehicle which may have a bed portion and a rail cap assembly which may be operably coupled to the bed portion. The bed rail cap assembly may include at least one extruded beam having a plurality of T-slot profiles. The plurality of T-slot profiles may be constructed and arranged to allow both horizontal and vertical attachment surfaces. Additionally, the bed rail cap assembly may be constructed and arranged to match a contour of the bed portion.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view according to a number of variations of the present invention.

FIG. 2A is a partial perspective view according to a number of variations of the present invention.

FIG. 2B is a blown up partial perspective view of FIG. 2A.

FIG. 3A is a perspective view according to a number of variations of the present invention.

FIG. 3B is a perspective view according to a number of variations of the present invention.

FIG. 3C is a perspective view according to a number of variations of the present invention.

FIG. 4 is a schematic view according to a number of variations of the present invention.

FIG. 5 is a schematic view according to a number of variations of the present invention.

FIG. 6 is a close-up perspective view according to a number of variations of the present invention.

FIG. 7 is an exploded perspective view according to a number of variations of the present invention.

FIG. 8 is an exploded perspective view according to a number of variations of the present invention.

FIG. 9 is a partial perspective view according to a number of variations of the present invention.

FIG. 10 is a partial perspective view according to a number of variations of the present invention.

FIG. 11 is a partial perspective view according to a number of variations of the present invention.

### DETAILED DESCRIPTION OF ILLUSTRATIVE VARIATIONS

The following description of the variations is merely illustrative in nature and is in no way intended to limit the scope of the invention, its application, or uses.

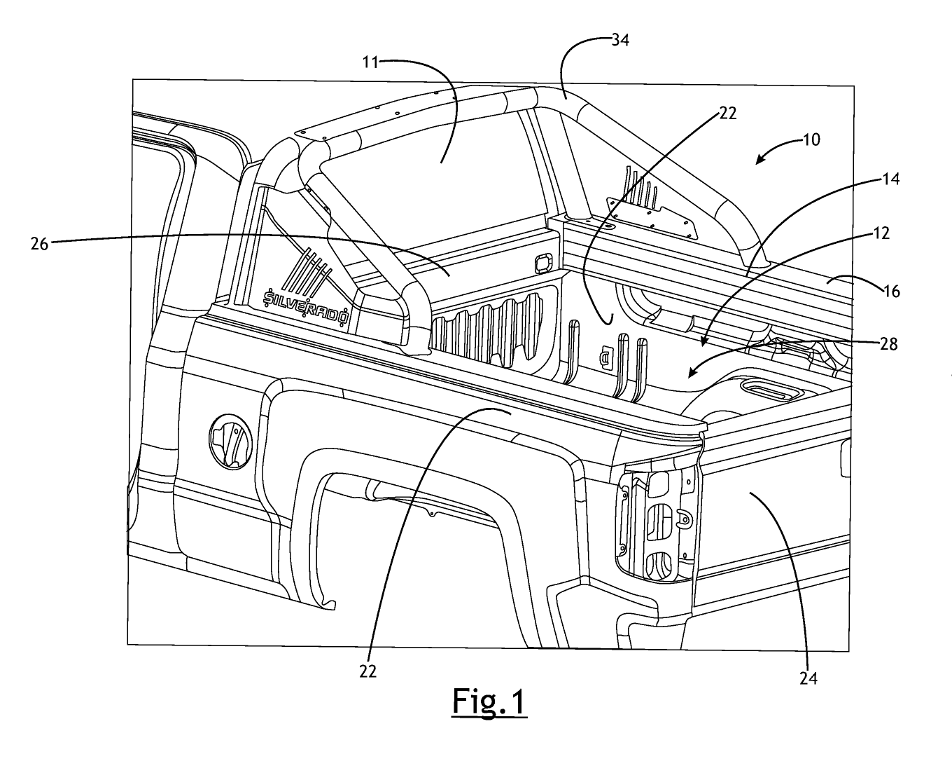

In FIGS. 1-11, a vehicle 10 may be provided and may include a bed portion 12. Additionally, a bed rail cap assembly 14 may be operably coupled to the bed portion 12. The bed rail cap assembly 14 may include at least one extruded beam 16 which may have a plurality of T-slot profiles 18. Additionally, the bed rail cap assembly 14 may be constructed and arranged to match a contour of the bed portion 12. In a number of variations, at least one extruded beam 16 may provide a means of conveniently mounting, dismounting, and/or powering a number of variations of vehicle accessories on the bed cap rails 14 of a vehicle 10 including, but not limited to, a pickup truck or similar vehicle. In a number of variations, the use of extruded beams 16, which may include industry standard T-slot profiles 18 arranged on multiple mounting planes and having at least one internal cavity may allow for at least one of hydraulic, pneumatic, and/or electric power to be routed within the one or more extruded beams 16. In a number of variations, the use of industry standard T-slot profiles 18 may also allow for the standardization and interchangeability of any number of various vehicle accessories. The use of one or more extruded beams 16, fasteners, and related components described hereafter, may also allow for ease of customization by the owner. Further, in a number of variations, the one or more extruded beams 16 may be fitted to the vehicle 10 so that it may appear as original vehicle equipment so that it may not detract from the visual appearance of the vehicle 10.

Referring to FIG. 1, in a number of variations, the vehicle 10 may be of any type of vehicle including but not limited to a truck, a car, a truck car hybrid, or any other vehicle as known by one of ordinary skill in the art. Additionally, the vehicle 10 may include a vehicle bed portion 12. The bed portion 12 may be a standard bed as known by one of ordinary skill in the art. In a number of variations, the bed portion 12 may be of any size or shape and may be operably coupled to a passenger cabin 11 of the vehicle 10. The bed portion 12 may have various contours or edges which may be of any shape, size or orientation. In a number of variations, the bed portion 12 may include at least two side walls 22 along with a front wall 24 and a back wall 26. In one variation, one or more of the front wall 24, back wall 26, or side walls 22 may be constructed and arranged to operate as a hatchback to allow easy access into a cavity 28 of the bed portion 12.

Referring again to FIG. 1, the vehicle bed 12 may be of any size, shape or configuration as known by one of ordinary skill in the art. Additionally, in a number of variations, the bed rail cap assembly 14 may be operably coupled to the vehicle 10 such that the bed rail cap assembly 14 perfectly matches a contour of the truck body and/or the vehicle bed 12. In a number of variations, the bed rail assembly 14 may also be constructed and arranged to be attached to any or all of the side walls 22, front wall 24, or back wall 26 of the vehicle bed 12 along with any other portion of the vehicle 10.

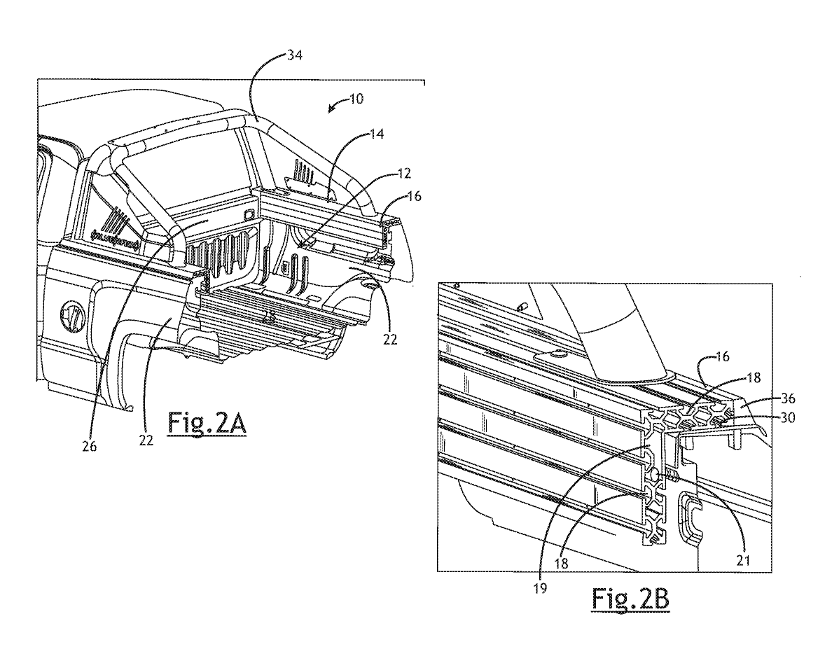

Referring to FIGS. 2A and 2B, in a number of variations, the bed rail cap assembly 14 may be fixed and/or attached to the vehicle lousing one or more channels 30 which may be disposed in the vehicle 10. In a number of variations, the one or more channels 30 may be disposed on one or more of the side walls 22, front wall 24, back wall 26 or other portions of the vehicle 10 as known by one of ordinary skill in the art. In a number of variations, the bed rail cap assembly 14 may include a trim portion 36, a variation of which is illustrated in FIG. 2B. The trim portion 36 may be constructed and arranged to be inserted into one or more of the channels 30 in order to secure it to the bed rail cap assembly 14 onto the vehicle 10. In one variation, the trim portion 36 may be formed by a molding operation as known by one of ordinary skill in the art or may be formed by another process as known by one of ordinary skill in the art.

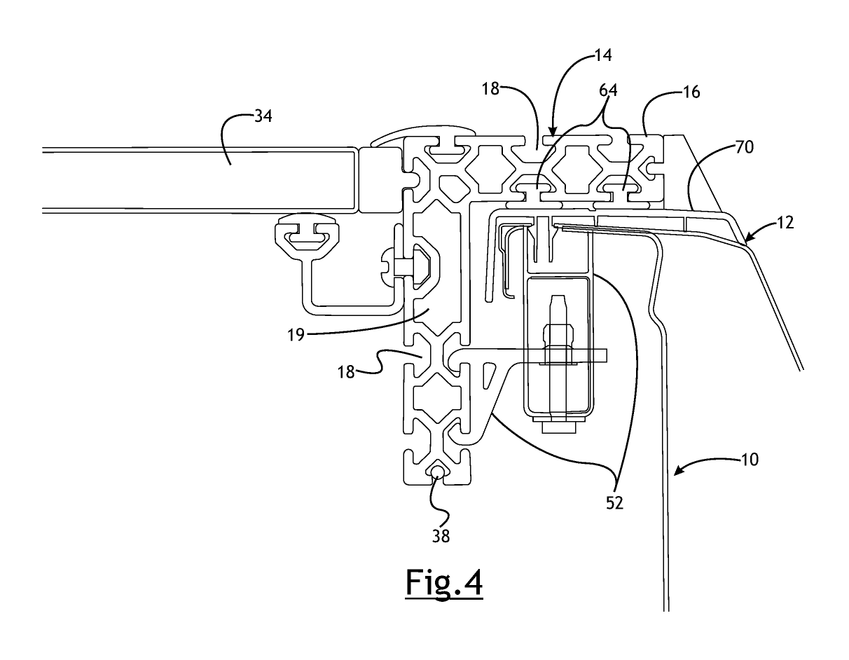

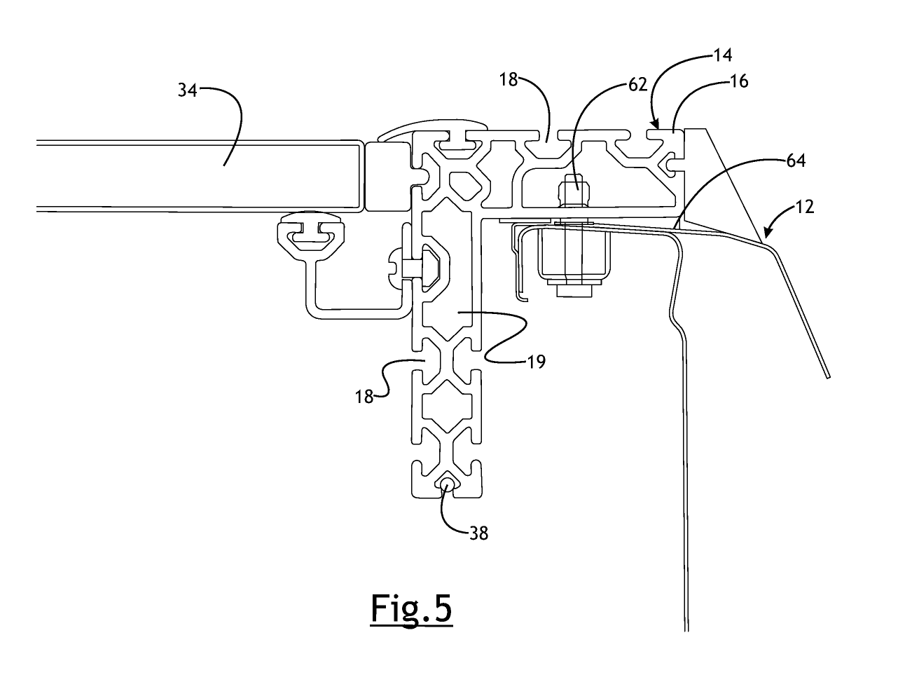

Referring again to FIGS. 2A and 2B, in a number of variations, the bed rail cap assembly 14 may include multiple T-slots 18 which may be constructed and arranged for mounting various and multiple accessories 34. In one variation, the T-slots 18 may be industry standard T-slot profiles as known by one of ordinary skill in the art. In a number of variations, the T-slots 18 may be fitted at each end and on an outside edge with a panel component 36 that matches the contour of the vehicle body. In a number of variations, the T-slot 18 may make use of industry standard size imperial (US customary) or metric T-slot profiles. The T-slots 18 may provide mounting for a number of accessories 34 or tools regardless of their manufacturer. Additionally, the T-slots 18 may provide standardization of mounting vehicle bed accessories including, but not limited to, ladder racks, sports bars, tonneau covers, cargo dividers, bed caps, tool boxes, and utility racks. Additionally, in a number of variations, one or more internal cavities 19 within the T-slot beam 16 may provide the capability to distribute hydraulic, pneumatic, and/or electric power down the length of the bed rail cap assembly. In one variation, an LED strip light or a LED rope light 38 may be inserted in one or more T-slots 18 in order to provide light to the vehicle bed 12 or other portions of the vehicle 10, variations of which are illustrated in FIGS. 4 and 5.

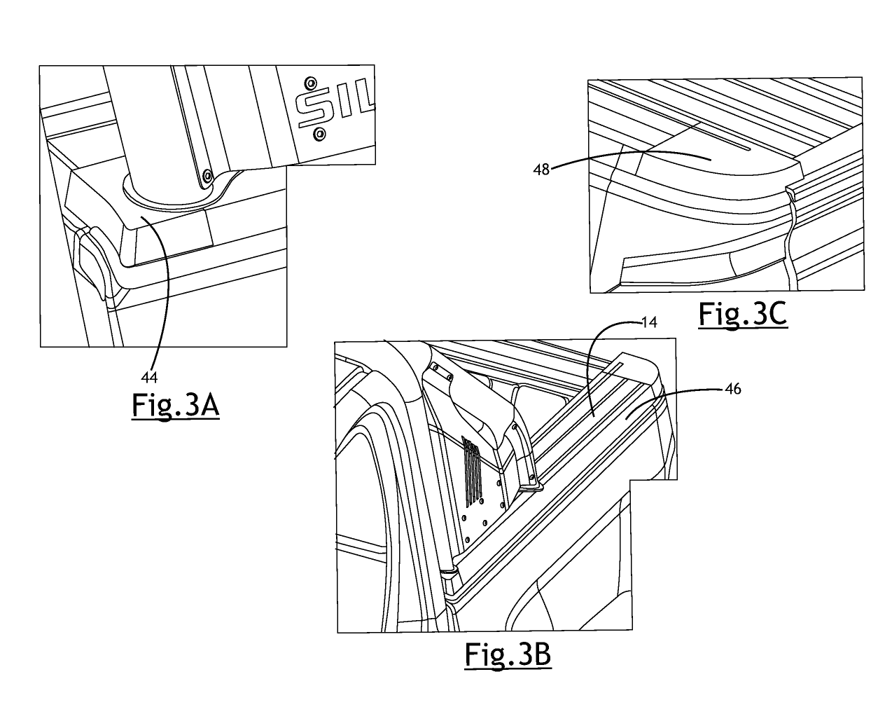

Referring to FIGS. 3A-3C, in a number of variations, the bed rail cap assembly 14 may include one or more panel components 44, 46, 48. The panel components 44, 46, 48 may be constructed and arranged for the bed rail cap assembly 14 to fit the contour of the vehicle 10 and/or the vehicle bed 12. The panel components 44, 46, 48 may be formed by a molding operation as known by one of ordinary skill in the art or may be formed by another process as known by one of ordinary skill in the art.

Referring to FIG. 3A, in a number of variations, the bed rail cap assembly 14 may include a front panel component 44. The front panel component 44 may be disposed on the side 22 or back wall 26 of the vehicle bed 12. As illustrated in FIG. 3A, the front panel component 44 may be generally rectangular or may be any other shape which may match the contour of the vehicle bed 12 and/or vehicle 10. In a number of variations, the front panel component 44 may be attached to the bed rail cap assembly 14 and/or the vehicle bed 12 by any means as known by one of ordinary skill in the art, including but not limited to external fixation devices including nails, screws, rivets, staples or sonic weld along with gluing and/or any other fixation means as known by one of ordinary skill in the art.

The bed rail cap assembly 14 may additionally include an outboard panel component 46 as illustrated in FIG. 3B and a rear panel component 48 as illustrated in FIG. 30. As illustrated in FIG. 3B, the outboard panel component 46 may be disposed along an outer edge of the bed rail cap assembly 14 and may be constructed and arranged to match the contour of one or more of the side walls 22 of the vehicle bed 12. In a number of variations, both side walls 22 of the vehicle bed may include outboard panel components 46. Additionally, in a number of variations, the outboard panel components 46 on each side of the side walls 22 may be the same shape or different shapes as desired in order to match the contour of the vehicle 10 and/or the vehicle bed 12.

Referring again to FIG. 3B, in a number of variations, the outboard panel component 46 may extend along the side wall 22 from the front wall 24 to the back wall 26 of the vehicle bed 12. In a number of variations, the outboard panel component 46 may be a single piece or may be multiple pieces in order to match the contour of the vehicle bed 12 and/or vehicle 10.

Referring to FIG. 30, in a number of variations, the bed rail cap assembly 14 may also include the rear panel component 48 which may be disposed at an end of the bed rail cap assembly 14. Again, the rear panel component 48 may be constructed and arranged to fit the contour of the vehicle bed 12. In a number of variations, at least a portion of the rear panel component 48 may overlap the rear wall 24 of the vehicle bed 12. In a number of variations, each of the side walls 22 of the vehicle bed may also include the rear panel component 48.

Referring to FIGS. 4-5, in a number of variations, the bed rail cap assembly 14 may be attached to the vehicle 10 according to many different methods. In one variation, a coupling assembly 52 may be used with the extruded T-slots 18, along with one or more isolators and/or a leveler 64 in order to couple the bed rail cap assembly 14 to the vehicle bed 12. FIG. 4 additionally shows a variation where a tonneau cover accessory 34 may be attached to the bed rail cap assembly 14 using one or more extruded beams 16 having T-slots 18. In a number of variations, the one or more extruded beams 16 having T-slots 18 may be positioned parallel to each other such that the accessory 34 (or any other accessory) may be placed anywhere fore or aft along the extruded beams 16. FIG. 4 also demonstrates that the rail cap assembly 14 may be assembled to the vehicle 10 as an accessory, in which case it may reside on top of an existing factory installed rail cap 70.

Referring to FIG. 5, the bed rail cap assembly 14 may be assembled to the vehicle bed 12 using a rivnut 62 along with a leveler 64. The leveler 64 may be disposed between the extruded beam 16 and the vehicle bed 12 in order to provide support for the bed rail cap assembly 14. Again, the accessory 34 (or any variation of an accessory) may be disposed in the T-slots 18. FIG. 5 also demonstrates that the rail cap assembly 14 may be installed as an accessory, after a factory installed rail cap is removed, or the rail cap assembly 14 may be installed at the factory as original equipment.

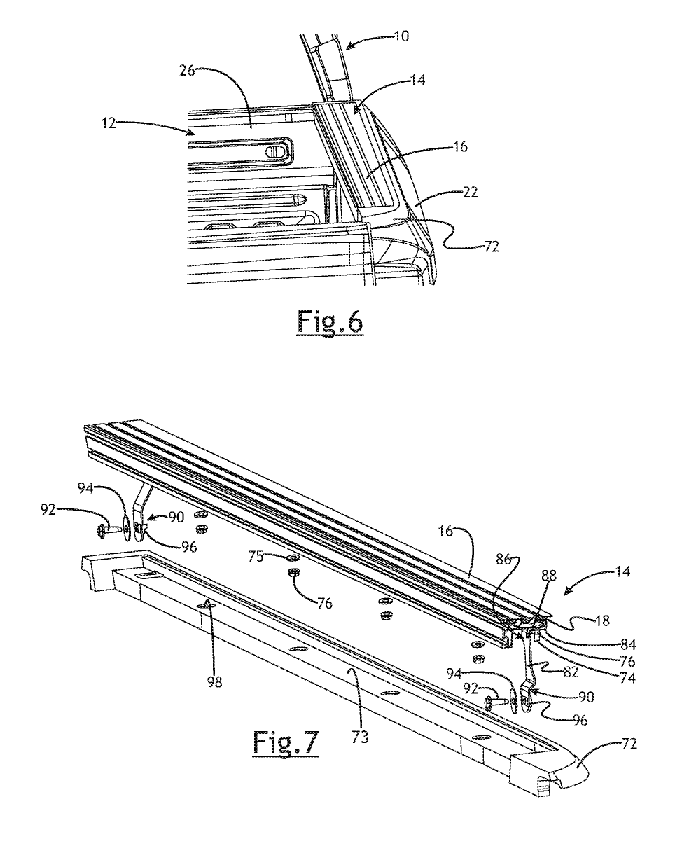

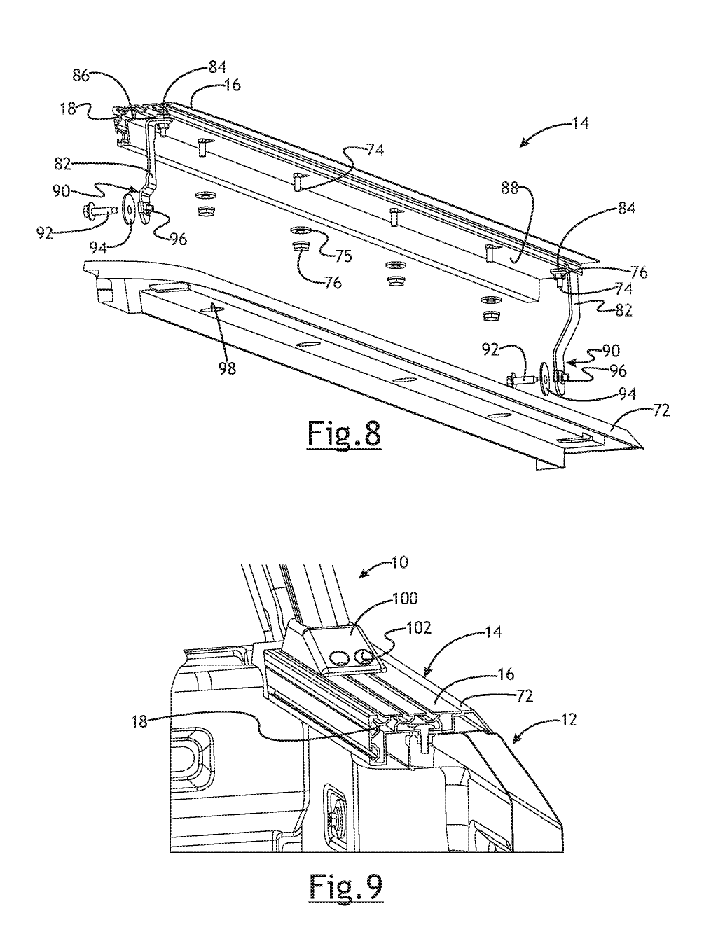

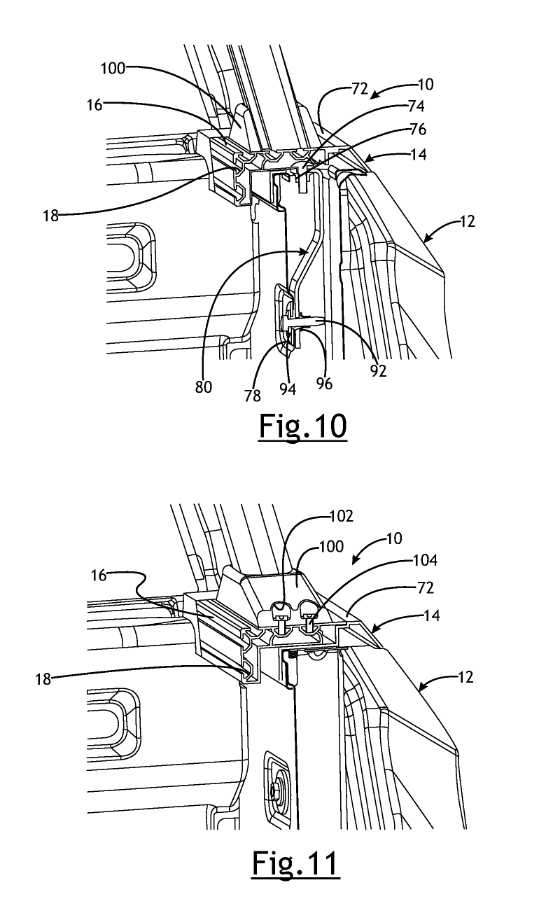

Referring to FIGS. 6-10, the rail cap assembly 14 may include one or more extruded beams 16 which may fit into a one-piece trim panel 72. In a number of variations, the one-piece trim panel 72 may contour the top of the side wall 22 of the vehicle bed 12 and may include a cutout 73 which may be constructed and arranged to accommodate the one or more extruded beams 16. The one-piece trim panel 72 may comprise any number of materials including, but not limited to, plastic. In a number of variations, the one or more extruded beams 16 may be parallel to each other. In a number of variations, the one-piece trim panel 72 may enable the rail cap assemblies 14 to precisely fit the contour of the vehicle 10. In a number of variations, the one-piece trim panel 72 and one or more extruded beams 16 may be attached to the side 22 and/or back wall 26 of the vehicle bed 12 with one or more mechanical fasteners including, but not limited to, one or more bolts 74, washers 75, and nuts 76, variations of which are illustrated in FIG. 8. The one-piece trim panel 72 and one or more extruded beams 16 may also be constructed and arranged to attach to at least one of the front or rear stake pocket 78 of the vehicle 10, a variation of which is illustrated in FIG. 10. In a number of variations, the one or more extruded beams 16 may include front and rear attachment hardware 80 which may be constructed and arranged to attach to the front and/or rear stake pocket 78 of the vehicle 10, a variation of which is also illustrated in FIG. 10. In one variation, the front and rear attachment hardware 80 may comprise a vertical bracket 82 which may include a first lip 84 at a first end 86 of the bracket 82 which may be constructed and arranged to attach to the underside 88 of the one or more extruded beams 16 using one or more mechanical fasteners including, but not limited to, bolts 74 and nuts 76, variations of which are illustrated in FIGS. 7 and 8. In a number of variations, the second end 90 of the bracket 82 may be constructed and arranged so that it may extend through an opening defined by an inner surface 98 in the one-piece trim panel 72, and so that it may laterally attach to the front or rear stake pocket 78 using one or more mechanical fasteners including, but not limited to, bolts 92, washers 94, and/or U-clips or U-nuts 96.

Referring to FIGS. 9 and 11, in a number of variations, an accessory including, but not limited to, a utility rack vertical support 100 (or other accessory) may be mounted to the one or more extruded beams 16. In this variation, the utility rack vertical support 100 (or other accessory) may include one or more openings defined by an inner surface 102 which may be constructed and arranged to accommodate one or more mechanical fasteners 104 including, but not limited to, a bolt, a variation of which is illustrated in FIG. 11. The mechanical fastener 104 may extend through the inner surface 102 of the utility rack vertical support 100 (or other accessory) and into the T-slots 18 to secure the utility rack vertical support 100 (or other accessory) to the one or more extruded beams 16.

In a number of variations, the mounting of the bed rail cap assembly 14 may not require the removal of standard OEM bed rail trim molding. In a number of variations, the bed rail cap assembly 14 may fit on top of standard OEM trim molding and may mount securely without the need to drill holes. Further, in a number of variations, the attachment provisions may be hidden so that they may not be visible to the casual observer which may further enhance the assemblies' aesthetic integration into the vehicle 10. Additionally by having standard industry T-slot extruded beams 16, a vehicle owner may easily create and add unique one of a kind accessories to the vehicle. Moreover, the electrical, pneumatic, or hydraulic power may be distributed along the rail cap assembly through the front or rear stake pocket openings in the vehicle bed. Moreover, power outlets may be attached directly or indirectly to the extruded beam 16. In a number of variations, the bed rail cap assembly 14 may be constructed and arranged to provide for both horizontal and vertical attachment surfaces.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a vehicle which may include a bed portion and a rail cap assembly operably coupled to the bed portion. The bed rail cap assembly may include at least one extruded beam which may have a plurality of T-slot profiles. Additionally, the bed rail cap assembly may be constructed and arranged to match a contour of the bed portion.

Variation 2 may include the vehicle as set forth in variation 1 wherein the bed rail cap assembly may be constructed and arranged to match every contour of the bed portion.

Variation 3 may include the vehicle as set forth in any of variations 1 to 2, wherein the T-slot profiles may be constructed and arranged to allow at least one accessory to be connected to the bed rail cap assembly.

Variation 4 may include the vehicle as set forth in any of variations 1 to 3 wherein the bed rail cap assembly may allow for both horizontal and vertical attachment surfaces.

Variation 5 may include the vehicle as set forth in any of variations 1 to 4 wherein the bed rail cap assembly may include integrated illumination.

Variation 6 may include the vehicle as set forth in any of variations 1 to 5 wherein the accessory may include at least one of a ladder rack, a sport bar, a tonneau cover, a cargo divider, a bed cap, a tool box, or a utility rack.

Variation 7 may include the vehicle as set forth in any of variations 1 to 6 wherein the bed rail cap assembly further comprises a one-piece trim panel which is constructed and arranged to accommodate the at least one extruded beam.

Variation 8 may include the vehicle as set forth in any of variations 1 to 6 wherein the bed rail cap assembly may further include an outboard panel component, a front panel component and a rear panel component.

Variation 9 may include the vehicle as set forth in any of variations 1 to 8 wherein the bed rail cap assembly may include at least one of electrical, pneumatic, or hydraulic power capability.

Variation 10 may include a vehicle bed which may have a vehicle portion and a bed rail cap assembly which may be operably coupled to the bed portion. The bed rail cap assembly may include at least one extruded beam having a plurality of T-slot profiles. The bed rail assembly may be constructed and arranged to match every contour of the bed portion.

Variation 11 may include the vehicle bed as set forth in variation 10 wherein the T-slot profiles may be constructed and arranged to allow at least one accessory to be connected to the bed rail cap assembly.

Variation 12 may include the vehicle bed as set forth in any of variations 10 to 11 wherein the bed rail cap assembly may allow both horizontal and vertical attachment surfaces.

Variation 13 may include the vehicle bed as set forth in any of variations 10 to 12 wherein the bed rail cap assembly may include integrated illumination.

Variation 14 may include the vehicle bed as set forth in any of variations 10 to 13 wherein the accessory may include at least one of a ladder rack, a sport bar, a tonneau cover, a cargo divider, a bed cap, a tool box, or a utility rack.

Variation 15 may include the vehicle bed of claim 10 wherein the bed rail cap assembly further comprises a one-piece trim panel which is constructed and arranged to accommodate the at least one extruded beam.

Variation 16 may include the vehicle bed as set forth in any of variations 10 to 14 wherein the bed rail cap assembly may further include an outboard panel component, a front panel component and a rear panel component.

Variation 17 may include the vehicle as set forth in any of variations 10 to 16 wherein the bed rail cap assembly may include at least one of electrical, pneumatic, or hydraulic power capability.

Variation 18 may include a vehicle which may include a bed portion, a bed rail cap assembly which may be operably coupled to the bed portion. The bed rail cap assembly may include at least one extruded beam having a plurality of T-slot profiles. The plurality of T-slot profiles may be constructed and arranged to allow both horizontal and vertical attachment surfaces. Additionally, the bed rail cap assembly may be constructed and arranged to match a contour of the bed portion.

Variation 19 may include the vehicle as set forth in variation 18 wherein the bed rail cap assembly may be constructed and arranged to match every contour of the bed portion.

Variation 20 may include the vehicle as set forth in any of variations 18 to 19 wherein the bed rail cap assembly may include integrated illumination.

Variation 21 may include the vehicle as set forth in any of variations 18 to 20 wherein the bed rail cap assembly may further include an outboard panel component, a front panel component and a rear panel component.

Variation 22 may include the vehicle as set forth in any of variations 18 to 21 wherein the bed rail cap assembly may include at least one of electrical, pneumatic, or hydraulic power capability.

The above description of select variations within the scope of the invention is merely illustrative in nature and, thus, variations or variants thereof are not to be regarded as a departure from the spirit and scope of the invention.

What is claimed is:

1. A vehicle comprising:
a bed portion, wherein the bed portion includes a front wall, a first side wall, a second side wall, and a back wall;
a bed rail cap assembly comprising at least one one-piece trim panel having an L-shaped groove, wherein the at least one one-piece trim panel is attached to at least one of the first side wall or the second side wall; at least one extruded L-shaped beam having a plurality of T-slot profiles, and wherein the at least one extruded L-shaped beam is seated in the L-shaped groove in the at least one one-piece trim panel.

2. (canceled)

3. The vehicle of claim 1, wherein the T-slot profiles are constructed and arranged to allow at least one accessory to be connected to the bed rail cap assembly.

4. (canceled)

5. The vehicle of claim 1, wherein the bed rail cap assembly includes integrated illumination.

6. (canceled)

7. (canceled)

8. The vehicle of claim 1, wherein the bed rail cap assembly includes at least one of electrical, pneumatic, or hydraulic power capability.

9. (canceled)

10. (canceled)

11. (canceled)

12. (canceled)

13. (canceled)

14. (canceled)

15. (canceled)

16. A vehicle comprising:
a bed portion having a first side rail, a second side rail, a back wall, and a front wall, at least one front stake pocket, and at least one rear stake pocket;
a bed rail cap assembly comprising at least one one-piece trim panel which extends an entire length of at least one of the first side rail or the second side rail, wherein the at least one one-piece trim panel includes a groove; at least one extruded beam having a plurality of T-slot profiles, wherein the at least one extruded beam is seated within the groove of the at least one one-piece trim panel, wherein the plurality of T-slot profiles are constructed and arranged to allow both horizontal and vertical attachment surfaces;
wherein the at least one one-piece trim panel and the at least one extruded beam are attached to at least one of the front stake pocket or the rear stake pocket; and
wherein the bed rail cap assembly is constructed and arranged to match a contour of the bed portion.

17. The vehicle of claim 16 wherein the bed rail cap assembly is constructed and arranged to match a contour of a top of at least one of the first side rail or the second side rail of the bed portion.

18. The vehicle of claim 16, wherein the bed rail cap assembly includes integrated illumination.

19. (canceled)

20. The vehicle of claim 16, wherein the bed rail cap assembly includes at least one of electrical, pneumatic, or hydraulic power capability.
